(19) United States
(12) Patent Application Publication
(10) Pub. No.: US 2017/0113602 A1
(43) Pub. Date: Apr. 27, 2017

(54) ILLUMINATED EXTERIOR BADGE

(71) Applicant: FORD GLOBAL TECHNOLOGIES, LLC, Dearborn, MI (US)

(72) Inventors: Stuart C. Salter, White Lake, MI (US); Paul Kenneth Dellock, Northville, MI (US); Michael A. Musleh, Canton, MI (US); Mehran Niksimaee, Orchard Lake Village, MI (US)

(21) Appl. No.: 14/921,390

(22) Filed: Oct. 23, 2015

(51) Int. Cl. B60Q 1/26; B60Q 1/50; B60Q 1/56

(52) U.S. Cl. CPC B60Q 1/2696; B60Q 1/56; B60Q 1/2615; B60Q 1/50

(57) ABSTRACT

An illuminated exterior badge assembly for a vehicle includes a vehicle body surface-mounted badge and a circuit board underlying the badge and comprising three independently actuable sets of light sources. A controller is operatively connected to the circuit board and configured to control one or more of an activation sequence or an illumination intensity of the three independently actuable sets of light sources. On detecting a vehicle start-up condition, the controller incrementally actuates the set of light sources beginning with one or more light sources associated with a center portion of the circuit board and proceeding to a plurality of light sources associated with a perimeter of the circuit board. The converse actuation pattern is observed on vehicle power-down.

### TECHNICAL FIELD

This disclosure relates generally to exterior badges for motor vehicles. More particularly, the disclosure relates to an illuminated exterior badge for a vehicle, which illuminates in particular patterns according to particular vehicle functions or signals to be given.

### BACKGROUND

While it is known to provide illuminated exterior badges for vehicles, typically there are regulations dictating particular ways that a badge may be illuminated. For example, conventionally regulations require that anterior (forward) vehicle lighting be a white color, while posterior (rear) lighting is typically red or yellow. Thus, indicating vehicle functions or conditions using a vehicle exterior badge can be hampered by such regulations.

### SUMMARY

In accordance with the purposes and benefits described herein, in one aspect the present disclosure provides an illuminated exterior badge assembly for a vehicle, including a vehicle body surface-mounted badge and a circuit board comprising a plurality of independently actuable sets of light sources. A controller operatively connected to the circuit board is configured to control one or more of an activation sequence or an illumination intensity of the plurality of independently actuable sets of light sources. Typically, the circuit board is disposed beneath the surface-mounted badge. In embodiments, the circuit board includes a first set of light sources emitting a first light color, intensity, and pattern, a second set of light sources emitting a second light color, intensity, and pattern, and a third set of light sources emitting a third light color, intensity, and pattern. In embodiments, the first light color, the second light color, and the third light color may be the same or different. In embodiments, the first light intensity, the second light intensity, and the third light intensity may be the same or different. In embodiments, the first light pattern, the second light pattern, and the third light pattern may be the same or different.

In another aspect, the present disclosure provides an illuminated exterior badge assembly for a vehicle, including a vehicle body surface-mounted badge and a circuit board underlying the badge and comprising three independently actuable sets of light sources. A controller is operatively connected to the circuit board and configured to control one or more of an activation sequence or an illumination intensity of the three independently actuable sets of light sources.

In embodiments, on detecting a vehicle start-up condition the controller is configured to incrementally actuate the set of light sources beginning with one or more light sources associated with a center portion of the circuit board and proceeding to a plurality of light sources associated with a perimeter of the circuit board. Conversely, on detecting a vehicle power-down condition the controller is configured to incrementally extinguish the set of light sources beginning with the plurality of light sources associated with the perimeter of the circuit board and proceeding to the one or more light sources disposed in the center portion of the circuit board.

In other embodiments, the controller is configured to intermittently actuate a second set of light sources on detection of a vehicle malfunction condition, to alternately actuate the second set of light sources and a third set of light sources on receipt of a signal such as from a vehicle key fob, and/or to intermittently actuate the second set of light sources on actuation of a vehicle emergency flasher system.

In yet another aspect, the present disclosure provides an illuminated exterior badge assembly for a vehicle including a vehicle body surface-mounted badge, a circuit board underlying the badge and comprising a plurality of independently actuable sets of light sources; and a controller. The controller is operatively connected to the circuit board and configured to control one or more of an activation sequence or an illumination intensity of the plurality of independently actuable sets of light sources. In turn, the controller is configured to actuate or extinguish a set of light sources in a predetermined incremental pattern on detecting a vehicle start-up or power-down condition.

In embodiments, on detecting the vehicle start-up the controller is configured to incrementally actuate the set of light sources beginning with one or more light sources associated with a center portion of the circuit board and proceeding to a plurality of light sources associated with a perimeter of the circuit board. Conversely, on detecting the vehicle power-down condition the controller is configured to incrementally extinguish the set of light sources beginning with the plurality of light sources associated with the perimeter of the circuit board and proceeding to the one or more light sources disposed in the center portion of the circuit board. In embodiments, the controller is configured to incrementally actuate the set of light sources beginning with the one or more light sources associated with the center portion of the circuit board and proceeding to incrementally illuminate light sources in a badge-vertical and a badge-horizontal direction providing a cross-shaped illumination pattern, and then to illuminate the plurality of light sources associated with a perimeter of the circuit board. Conversely, the controller is configured to incrementally extinguish the set of light sources beginning with the plurality of light sources associated with the perimeter of the circuit board and proceeding in the badge-vertical and a badge-horizontal direction to extinguish the one or more light sources disposed in the center portion of the circuit board.

In the following description, there are shown and described embodiments of the disclosed vehicle illuminated exterior badge. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed illuminated exterior badge, and together with the description serve to explain certain principles thereof. In the drawing:

FIG. 1 depicts a vehicle including an exterior badge:

FIG. 2 depicts an illuminated exterior badge assembly according to the present disclosure;

FIG. 3 illustrates a representative control schematic for the badge of FIG. 2;

FIG. 4A illustrates a representative activation pattern of the badge assembly of FIG. 2;

FIG. 4B illustrates continued activation of the badge assembly of FIG. 2;

FIG. 4C illustrates continued activation of the badge assembly of FIG. 2; and

FIG. 4D illustrates continued activation of the badge assembly of FIG. 2.

Reference will now be made in detail to embodiments of the disclosed illuminated exterior badge, examples of which are illustrated in the accompanying drawing figures.

### DETAILED DESCRIPTION

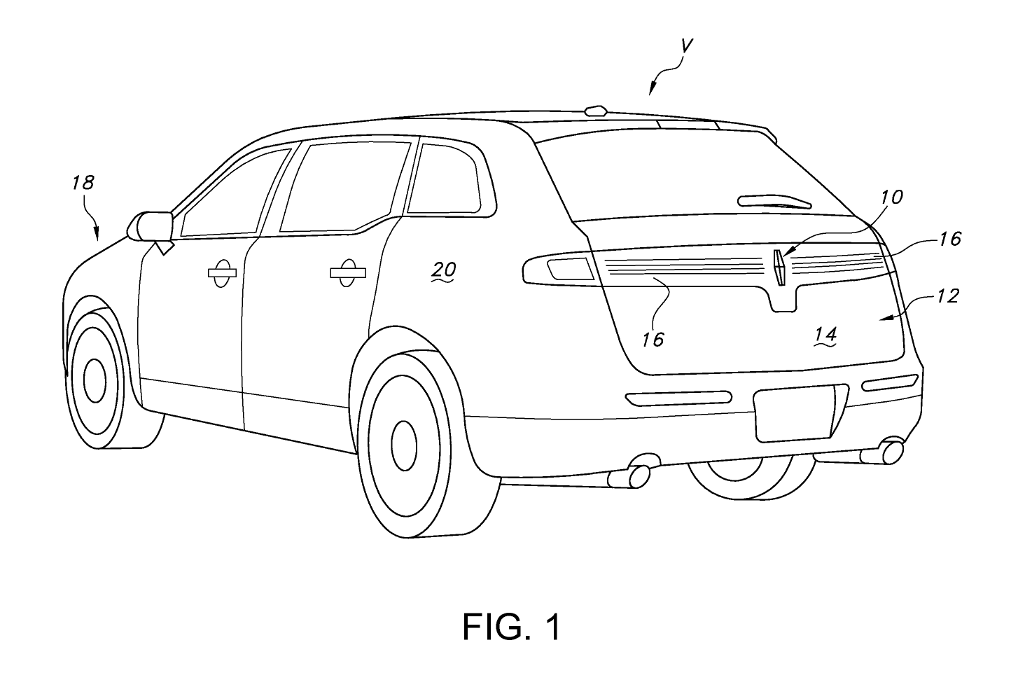

With reference to FIG. 1 as is known a vehicle badge 10 may be mounted on various vehicle V surfaces, including at a rear end 12 of the vehicle. As shown, the badge 10 is mounted on a rear door 14 of the vehicle V, between a set of running/brake lights 16. In other embodiments, the badge 10 may be mounted on a front end 18 of the vehicle V, on a side 20 of the vehicle, etc. All such placements are contemplated for the exterior badge assembly disclosed herein.

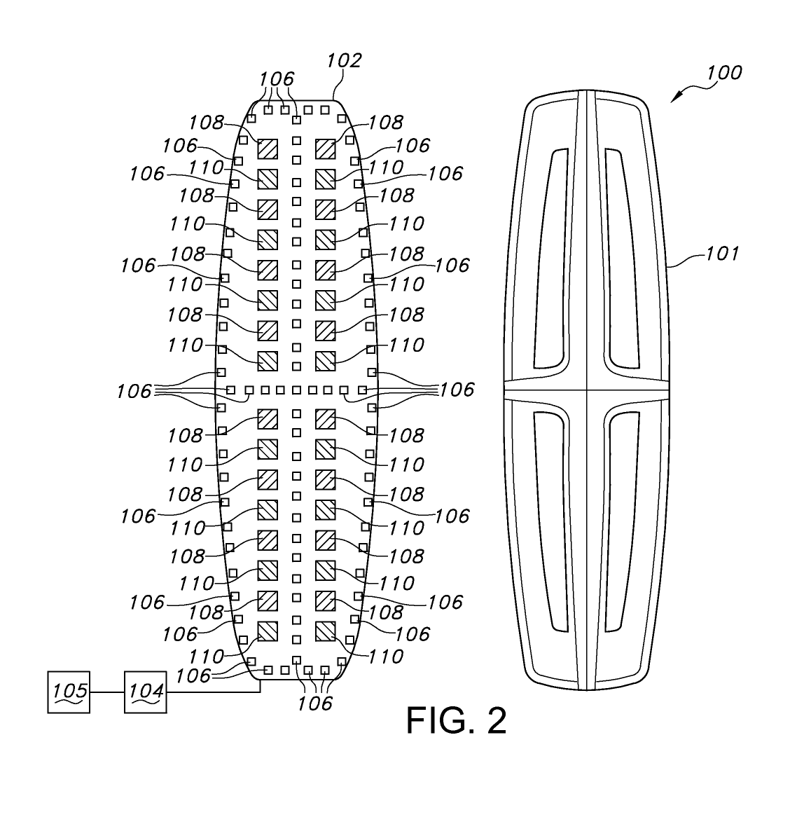

As shown in FIG. 2, the present disclosure describes an illuminated exterior badge 100 including an underlying circuit board 102 including a series of associated light sources. In embodiments, the circuit board 102 is a printed circuit board (PCB). The exterior badge 100 includes an outer shell 101 which in use overlays the circuit board 102 and which may be configured in any desired shape, such as for example an emblem or logo associated with a particular vehicle and/or vehicle manufacturer. As is known, the outer shell 101 may be fabricated of any of a number of suitable materials, may be partially vacuum metalized on an outer surface thereof, may be deadfronted (i.e. of an opaque or semi-opaque plastic), etc. One or more controllers 104 operatively associated with the circuit board 102 in turn control illumination patterns of the light sources.

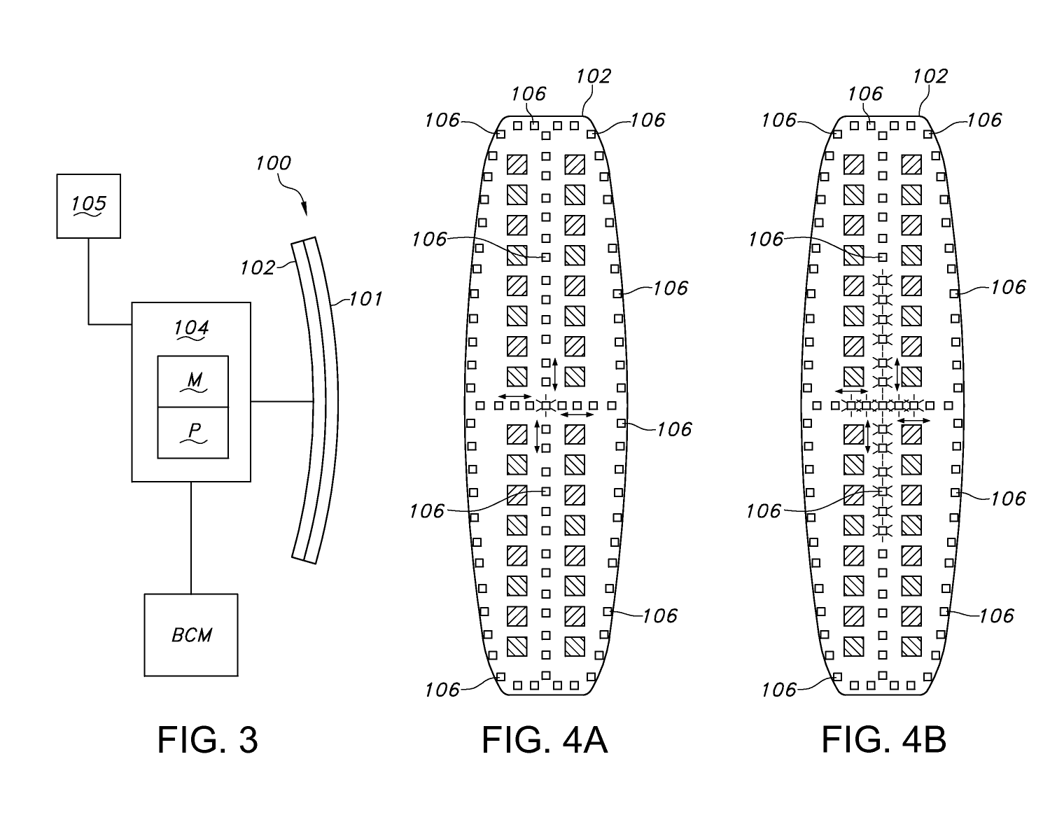

The badge 100 and controller 104 are further associated with a power source 105 for providing current to the circuit board 102 and light sources. As will be appreciated, that power source 105 may be a vehicle power source such as a battery, or may be an independent power source associated with the badge 100. This is shown in greater detail in FIG. 3, illustrating a control schematic for an exterior illuminated badge 100 including a controller 104 that in the depicted embodiment is a microprocessor including a memory M and at least one processor P. As shown, the controller 104 is further operatively associated with a vehicle control module such as a basic control module (BCM) by way of which certain functions of the illuminated exterior badge 100 as discussed below may be controlled and implemented.

A variety of light sources may be disposed on the circuit board 102, in accordance with the light pattern to be displayed and/or the function to be indicated by the illuminated exterior badge 100. The light sources may be provided by means of a plurality of light-emitting diodes (LEDs) arrayed on the circuit board 102. Advantageously, this eliminates a need for more complex methods for causing emission of light under and/or through the shell 101, such as for example light pipes or similar devices, while still providing a controlled, even illumination pattern.

In an embodiment, a first set of LEDs 106 of a first color and intensity may be arrayed along a perimeter of the circuit board 102, and also in an interior of the circuit board 102. As shown, the LEDs 106 are arrayed in a cross-shaped pattern in an interior of the circuit board 102, and then along the perimeter of the board as described. In turn, additional LEDs may be arrayed in other portions of the circuit board 102. In the depicted embodiment, a second set of LEDs 108 of a second color and/or a second intensity and a third set of LEDs 110 of a third color and/or a third intensity are disposed in the interior of the circuit board 102. As will be appreciated, multiple combinations of LED number, color and intensity are possible. In the depicted embodiment, LEDs 106 and 108 emit a same color (white) at a different intensity, while LEDs 108 and 110 emit a different color (red) at a same intensity. Of course, different combinations of LED color and/or intensity are possible and contemplated for use herein. For example, additional LED sets could be included emitting an amber color for a different warning or alert signal.

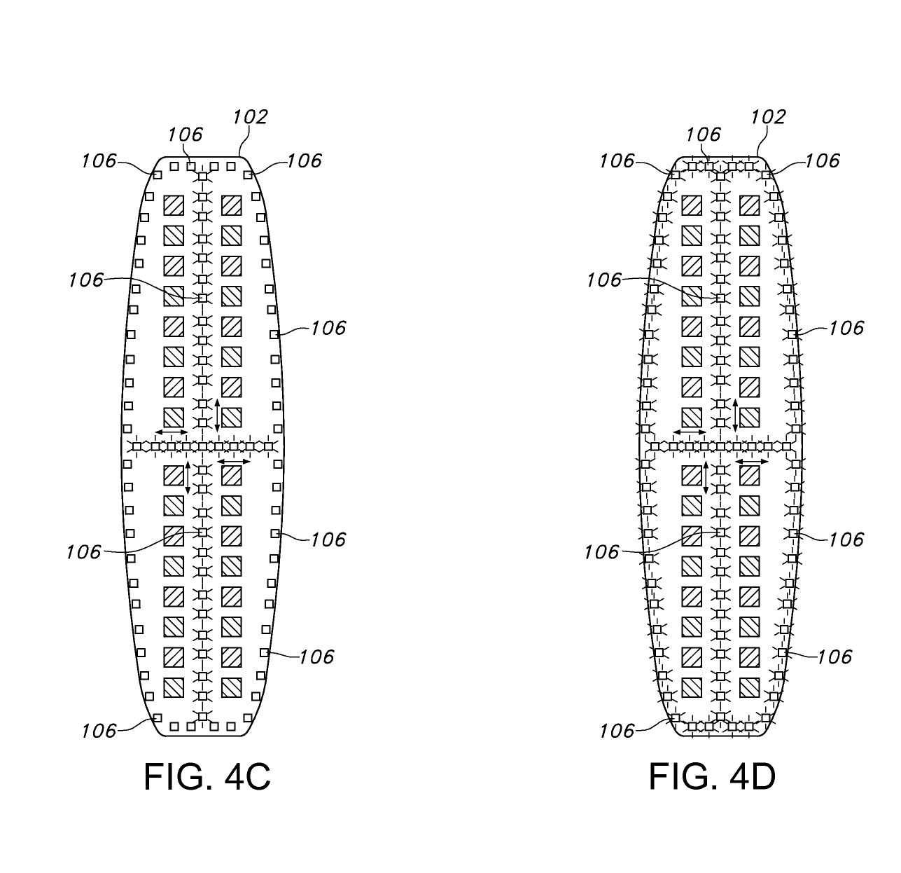

In the depicted embodiment LEDs 106 are relatively smaller and/or less intense LEDs emitting white light, and illuminate in a predetermined desired pattern on vehicle start-up as an indicator to the operator that the vehicle (not shown) and its various systems are powering up/powered up. For example (see FIGS. 4A-4D), on vehicle start-up the controller 104 may cause the LEDs 106 to illuminate in an incremental “inside-out” pattern (see arrows) wherein the illumination of LEDs 106 begins at a center of the LED 106 array (FIG. 4A) and proceeds sequentially (FIGS. 4A-4C) to provide an X-shaped illumination pattern (FIG. 4C). The controller 104 then proceeds to illuminate the perimeter LEDs 106 (FIG. 4D). In turn, the LEDs 106 may be extinguished in an incremental “outside-in” pattern from the perimeter LEDs 106 to the interior LEDs 106 on vehicle power-down.

In turn, LEDs 108 may be provided in the interior of the circuit board 102 that also emit a white light but are capable of emitting an increased wattage compared to LEDs 106. When the illuminated exterior badge 100 is provided as a rear vehicle badge, such LEDs 108 may illuminate when an operator places the vehicle in reverse, i.e. as auxiliary “backup” lights.

Still more, LEDs 110 that are of a similar intensity but a different color than LEDs 108 may be provided. In the depicted example, LEDs 110 emit a red color. When used in a badge 100 disposed at a front and/or rear of a vehicle, the red LEDs 110 may serve as auxiliary running lights during vehicle operation, to increase vehicle visibility. For badges 100 disposed both at a front and a rear of a vehicle, the controller 105 may cause LEDs 110 to illuminate intermittently on or after vehicle start-up to indicate a vehicle malfunction or “trouble” condition detected by one or more vehicle sensors, for example a low tire pressure condition, a low oil pressure condition, a high engine temperature condition, a “check engine” code, and others. This is accomplished by an operative association of controller 104 with a vehicle control module such as the BCM. Thus, as the owner starts the vehicle or approaches the vehicle after a remote start-up, she is immediately made aware that there is a potentially problematic vehicle condition that should be investigated.

Various safeguards may be implemented to guard against excessive heat generation by the badge 100. For example, on or before illumination of LEDs 108, LEDs 106 may be extinguished to prevent excessive heat buildup. To further reduce excess heat generation, LEDs 106, 108, and/or 110 may be serially connected. Still more, a temperature sensor associated with the microprocessor 104 may be used to determine a temperature of the illuminated exterior badge 100 and/or an ambient temperature adjacent to the vehicle, to prevent excessive heat generation by the badge. As will be appreciated, this arrangement allows a determination of ambient temperature to be factored into calculations determining an amount of current passed to the badge 100, number of LEDs illuminated, etc. For example, in very high ambient temperatures and/or if the vehicle engine is generating significant heat, less current is passed to the badge 100 and/or fewer LEDs are illuminated, thus reducing the amount of heat generated.

Of course, additional functions may be implemented by use of the above-described LED arrangement. For example, the controller 104 may cause the LEDs 110 to flash intermittently when the vehicle emergency flashers are actuated, thus further enhancing vehicle visibility. Still more, the illuminated badge 100 may be used as a vehicle finding tool, for example in a crowded parking lot. This may be accomplished by causing the LEDs 108 and/or LEDs 110 to illuminate intermittently when a vehicle operator actuates a “panic” button on, e.g. a key fob or the like, or when a “smart” key is in sufficient proximity to the owner's vehicle. This will draw the operator's attention to his car. As non-limiting examples, under the control of controller 104 the LEDs 108 may flash intermittently, LEDs 110 may flash intermittently, or LEDs 108 and LEDs 110 may alternate flashing intermittently for even more visibility.

Obvious modifications and variations are possible in light of the above teachings. For example, alternative sequences for activation of one or more of the described sets of LEDs 106, 108, 110 by microprocessor 104 are possible. In turn, additional or fewer sets of LEDs of the same or differing colors/intensities may be provide to create alternative illumination patterns and/or intensities. All such modifications and variations are within the scope of the appended claims when interpreted in accordance with the breadth to which they are fairly, legally and equitably entitled.

What is claimed:

1. An illuminated exterior badge assembly for a vehicle, comprising:
a vehicle body surface-mounted badge;
a circuit board comprising a plurality of independently actuable sets of light sources; and
a controller operatively connected to the circuit board and configured to control one or more of an activation sequence or an illumination intensity of the plurality of independently actuable sets of light sources.

2. The assembly of claim 1, wherein the circuit board is disposed beneath the surface-mounted badge.

3. The assembly of claim 1, including a first set of light sources emitting a first light color, intensity, and pattern, a second set of light sources emitting a second light color, intensity, and pattern, and a third set of light sources emitting a third light color, intensity, and pattern.

4. The assembly of claim 3, wherein the first light color, the second light color, and the third light color are the same or different.

5. The assembly of claim 3, wherein the first light intensity, the second light intensity, and the third light intensity are the same or different.

6. The assembly of claim 3, wherein the first light pattern, the second light pattern, and the third light pattern are the same or different.

7. A vehicle including the assembly of claim 1.

8. An illuminated exterior badge assembly for a vehicle, comprising:
a vehicle body surface-mounted badge;
a circuit board underlying the badge and comprising three independently actuable sets of light sources; and
a controller operatively connected to the circuit board and configured to control one or more of an activation sequence or an illumination intensity of the three independently actuable sets of light sources.

9. The assembly of claim 8, wherein on detecting a vehicle start-up condition the controller is configured to incrementally actuate the set of light sources beginning with one or more light sources associated with a center portion of the circuit board and proceeding to a plurality of light sources associated with a perimeter of the circuit board.

10. The assembly of claim 9, wherein on detecting a vehicle power-down condition the controller is configured to incrementally extinguish the set of light sources beginning with the plurality of light sources associated with the perimeter of the circuit board and proceeding to the one or more light sources disposed in the center portion of the circuit board.

11. The assembly of claim 8, wherein the controller is configured to intermittently actuate a second set of light sources on detection of a vehicle malfunction condition.

12. The assembly of claim 11, wherein the controller is configured to alternately actuate the second set of light sources and a third set of light sources on receipt of a signal from a vehicle key fob.

13. The assembly of claim 11, wherein the controller is configured to intermittently actuate the second set of light sources on actuation of a vehicle emergency flasher system.

14. A vehicle including the assembly of claim 8.

15. An illuminated exterior badge assembly for a vehicle, comprising:
a vehicle body surface-mounted badge;
a circuit board underlying the badge and comprising a plurality of independently actuable sets of light sources; and
a controller operatively connected to the circuit board and configured to control one or more of an activation sequence or an illumination intensity of the plurality of independently actuable sets of light sources;
wherein the controller is configured to actuate or extinguish a set of light sources in a predetermined incremental pattern on detecting a vehicle start-up or power-down condition.

16. The assembly of claim 15, wherein on detecting the vehicle start-up condition the controller is configured to incrementally actuate the set of light sources beginning with one or more light sources associated with a center portion of the circuit board and proceeding to a plurality of light sources associated with a perimeter of the circuit board.

17. The assembly of claim 15, wherein on detecting the vehicle power-down condition the controller is configured to incrementally extinguish the set of light sources beginning with the plurality of light sources associated with the perimeter of the circuit board and proceeding to the one or more light sources disposed in the center portion of the circuit board.

18. The assembly of claim 16, wherein the controller is configured to incrementally actuate the set of light sources beginning with the one or more light sources associated with the center portion of the circuit board and proceeding to incrementally illuminate light sources in a badge-vertical and a badge-horizontal direction providing a cross-shaped illumination pattern, and then to illuminate the plurality of light sources associated with a perimeter of the circuit board.

19. The assembly of claim 17, wherein the controller is configured to incrementally extinguish the set of light sources beginning with the plurality of light sources associated with the perimeter of the circuit board and proceeding in the badge-vertical and a badge-horizontal direction to extinguish the one or more light sources disposed in the center portion of the circuit board.

20. A vehicle including the assembly of claim 15.
